(19) United States
(12) Patent Application Publication
(10) Pub. No.: US 2009/0205400 A1
(43) Pub. Date: Aug. 20, 2009

(54) SYSTEM AND METHOD FOR MEASURING FLUID FLOW

(76) Inventor: LUTHER DONALD MCPEAK, Social Circle, GA (US)

Correspondence Address: KAPLAN WARD & PATEL LLC, CUMBERLAND CENTER II, 3100 CUMBERLAND BLVD , SUITE 1400, ATLANTA, GA, 30339, US

(21) Appl. No.: 12/371,408

(22) Filed: Feb. 13, 2009

Related U.S. Application Data
(60) Provisional application No. 61/029,327, filed on Feb. 16, 2008.

(51) Int. Cl. G01F 7/00; G01F 25/00

(52) U.S. Cl. 73/1.16; 73/197

(57) ABSTRACT

A compound fluid flow metering system including two electromagnetic fluid flow meters is disclosed that substantially increases accuracy of metering total volumes and flow rates and provides consistent accuracy over time. Additionally, the compound fluid flow metering system is substantially maintenance free, and reduces pumping costs associated with maintaining adequate supply pressures.

### RELATED APPLICATIONS

The present Nonprovisional Patent Application is related to, and hereby claims priority to, and the benefit of the effective filing date of, U.S. Provisional Application Number 61/029,327 entitled “System and Method for Measuring Fluid Flow” filed Feb. 16, 2008.

### TECHNICAL FIELD

The present invention relates generally to measuring and testing the flow rate of water, and, more particularly, to a an improved compound meter mechanism for measuring flow rate where there is too wide a range of flow to be accurately measured by one flow meter.

### BACKGROUND OF THE INVENTION

In numerous applications, measurement of flow rate and/or total volume of water flow is necessary. Accordingly, many different systems have been developed to enable measurement of water flow rate or volume values typically encountered in a selected application. Mechanical devices, such as jet meters and turbine meters, have long been used to meter total volumes of liquid flows via mechanical interaction with the liquid. However, such mechanical devices are relatively inaccurate compared to alternative metering devices. Furthermore, such mechanical devices are prone to wear, thus requiring maintenance and/or replacement thereof within 3 to 8 years, and are susceptible to damage from any debris carried in the liquid flow. Even with regular maintenance, the accuracy of such mechanical devices decreases as the components wear, so that the optimum accuracy cannot be maintained over time. Another adverse effect of such wear relates to the cost associated with providing a motive force, i.e. a pressure, required to create flow, which cost increases as the components of such mechanical devices wear. Further maintenance and additional cost and inconvenience is required to remove any debris that may be present, such as by mechanical filtration. Finally, the cost of manufacturing such mechanical devices increases disproportionally with the size of the device, making mechanical meters extremely costly for large diameter conduit applications.

Electromagnetic fluid flow meters, referred to as “mag meters”, offer an alternative to such mechanical meters. Utilizing Faraday's Law, mag meters can measure the flow rate of an electrically conductive fluid between two electrodes. Since no moving parts are included, mag meters are suitable for measuring water flows where particulate or other debris may be present, without filtration and without wear on the meter. Since there is no wear on the meter, the accuracy of mag meters does not decrease over time, and the pumping cost of the water is not increased. Furthermore, the cost of a mag meter does not increase significantly with the size of the device. Thus, mag meters are more cost-efficient for large diameter conduit applications.

Mag meters do, however, require a source of electricity in order to function, so in the past mag meters needed to be installed at a location in which a constant AC power source was available. However, the recent development of lithium battery powered mag meters has enabled the use of such meters in more remote locations. It is anticipated that mag meters will become available that utilize other independent power sources such as a solar power generator.

Another consideration in fluid flow metering pertains to the level of accuracy required for, and the range of flow rate values encountered in, the selected application. Even the most accurate meters exhibit relatively greater inaccuracy for certain values of fluid flow rate. Thus, selection of an appropriate metering device is critical in achieving required accuracy in fluid flow metering for the selected application. In some applications, such as in potable water supply applications, fluid flow rate values that are typically encountered vary within a range broad enough to preclude accurate metering using a single metering device. That is to say, in some applications the range of encountered fluid flow rate values is so broad that the inaccuracy of any given meter at some of the encountered flow rates is substantial enough to lower the overall accuracy of the metering system to an unacceptable level. In such circumstances, a compound meter may be employed, wherein two or more metering devices are included, with each metering device adapted to accurately measure flow rates within a predetermined range. For example, when small flow rate values are encountered, such flows may be metered by a first “low flow” meter, and when higher flow rate values are encountered, they may be measured by a second parallel “high flow” meter, in conjunction with the first meter.

The division of metering duty between the first and second meters may be accomplished via parallel arrangement of the meters and a flow control device. In such a configuration, the flow control device operates to prevent flow through the larger meter during low flow rates until sufficient downstream demand triggers the flow control device to allow flow through the larger meter. Thereafter, liquid may flow through both the first and second meters, and the flow rates and/or volumes may be recorded and processed. In a typical compound meter for liquids, a turbine meter is selected for the high flow meter and a multi-jet meter is selected for the low flow meter, and neither will indicate rate of fluid flow.

Accordingly, such compound metering systems suffer from the numerous disadvantages associated with mechanical metering devices, including high maintenance costs, decreasing accuracy over time, high pumping costs, and high costs for devices for large conduit size due applications.

Mag meters have not typically been employed for such compound metering applications, perhaps due to limited power availability, or simply due to tradition. Compound metering of water flow using electro mag meters would be beneficial, as it may provide accuracy of about 0.2% of flow rate, where traditional turbine based compound meters start at an accuracy of about 1.5%. Such a compound mag meter may be capable of providing this high level of accuracy across the entire flow range of the meter, and the accuracy will not deteriorate, as is common with turbine meters.

Thus, it is clear that there is an unmet need for a system utilizing compound electro mag meters for accurately measuring a broad range of liquid flow rate and volume values for use in essentially any size and shape conduit, including but not limited to large diameter conduit applications.

### BRIEF SUMMARY OF THE INVENTION

Briefly described, in a preferred embodiment, the present invention overcomes the above-mentioned disadvantages and meets the recognized need for such a system and method by providing a compound water flow metering system having two electromagnetic metering devices operable with respective associated parallel conduits and a flow control device, wherein inaccuracies associated with diverse flow rates and flow irregularities are reduced or eliminated.

More specifically, the system includes a first high-flow electromagnetic metering device operable with a large diameter conduit, a second low-flow electromagnetic metering device operable with a small diameter conduit, and a flow control valve operable with the large diameter conduit. The large diameter conduit includes a first upstream end that is configured to mate with a supply line in operable connection with a source of the metered liquid, and preferably has an internal cross-sectional shape and size appropriate for an internal cross-sectional shape and size of the supply conduit. The high-flow electromagnetic metering device is located at a first distance from the first end of the large diameter conduit, and is operable to measure the velocity of liquid flowing through the conduit.

The flow control valve is disposed within the large diameter conduit at a second distance from the high flow electromagnetic metering device and is operable to prevent flow within the large diameter conduit at levels of high differential between the pressure upstream of the valve and downstream of the valve, such as a threshold associated with a minimum flow rate selected for the high-flow electromagnetic metering device. The flow control valve is preferably located downstream of the high flow electromagnetic metering device proximate a second end of the large diameter conduit. The second end of the large diameter conduit is disposed at a third distance from electromagnetic metering device and is adapted to mate with an outlet conduit, and preferably has an internal cross-sectional size and shape that is appropriate for an internal cross-sectional size and shape of the outlet conduit.

A first end of the small diameter conduit is preferably in fluid communication with the large diameter conduit proximate the first end of the large diameter conduit, whereby liquid may flow into the small diameter conduit regardless of whether the flow control valve is open or closed; i.e., the first end of the small diameter conduit is operable with the large diameter conduit upstream of the high flow electromagnetic metering device and upstream of the flow control valve. The second end of the small diameter conduit is preferably in fluid communication with the large diameter conduit proximate the second end of the large diameter conduit, at a location downstream of the flow control valve. Thus, the small diameter conduit acts as a bypass of the high flow electromagnetic metering device and the flow control valve, whereby liquid may flow through the small diameter conduit at rates below the minimum flow rate selected for the high flow electromagnetic metering device.

The cross-sectional shape and size of the supply conduit, the first and second ends of the large diameter conduit, and the outlet conduit are preferably configured to reduce flow irregularities in a liquid flowing therethrough, whereby accuracy of the high flow electromagnetic metering device may be unhindered. Similarly, the flow control valve and the saddle joints are preferably configured and positioned to reduce turbulence associated with liquid flow therethrough to eliminate a potential barrier to using electromagnetic metering devices in such a compound meter application.

The electromagnetic metering devices of the present invention may be AC powered, or may utilize an independent power source such as lithium battery units, alkaline batteries, or a solar power generator, to reduce the concerns about providing a power source for meters installed in relatively remote locations.

Accordingly, a feature and advantage of the present invention is its ability to allow cost-effective, low-maintenance, and consistently accurate compound metering of fluid flow in large conduit applications.

Another feature and advantage of the present invention is its ability to increase the accuracy of compound metering systems.

Yet another feature and advantage of the present invention is its ability to reduce maintenance, repair, and pumping costs of compound metering systems.

Still another feature and advantage of the present invention is the ability to self-test the compound metering system without employing third party testing companies or expensive equipment.

These and other features and advantages of the present invention will become more apparent to those ordinarily skilled in the art after reading the following Detailed Description of the Invention and Claims in light of the accompanying Figures.

### BRIEF DESCRIPTION OF THE DRAWINGS

Accordingly, the present invention will be understood best through consideration of, and with reference to, the following drawings, viewed in conjunction with the Detailed Description of the Invention referring thereto, in which like reference numbers throughout the various drawings designate like structure, and in which:

FIG. 1 is a side perspective view of a compound metering system according to the present invention; and

FIG. 2 is a cross-sectional view of a flow control device of the system of FIG. 1.

FIG. 3 is a perspective view of a compound metering system according to the present invention and illustrating a method for testing the system as herein described.

It is to be noted that the drawings presented are intended solely for the purpose of illustration and that they are, therefore, neither desired nor intended to limit the invention to any or all of the exact details of construction shown, except insofar as they may be deemed essential to the claimed invention.

### DETAILED DESCRIPTION OF THE INVENTION

In describing preferred embodiments of the present invention illustrated in the drawings, specific terminology is employed for the sake of clarity. The invention, however, is not intended to be limited to the specific terminology so selected, and it is to be understood that each specific element includes all technical equivalents that operate in a similar manner to accomplish a similar purpose.

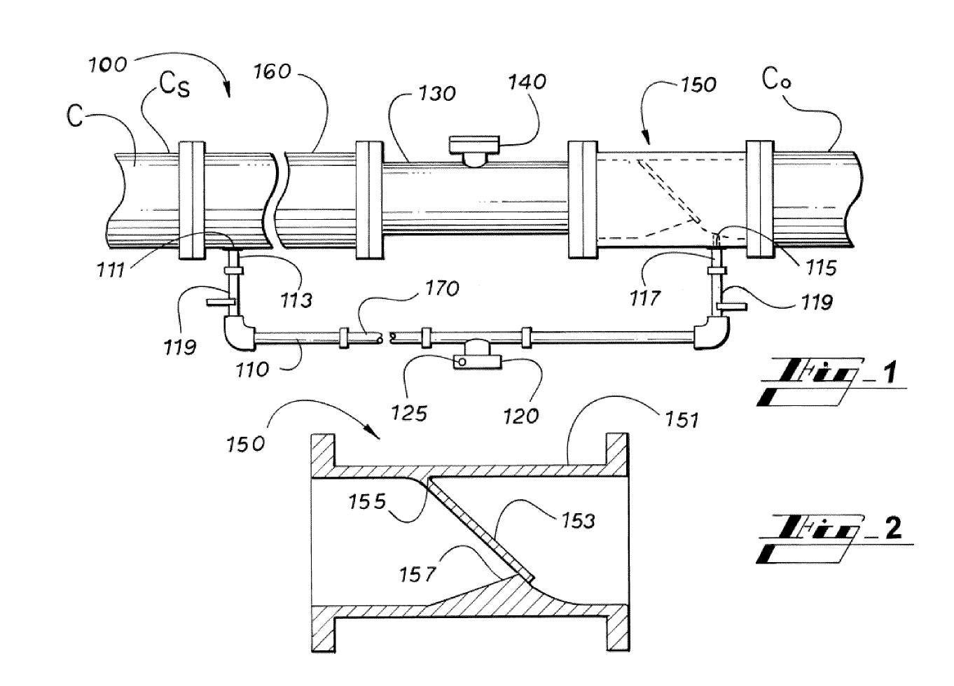

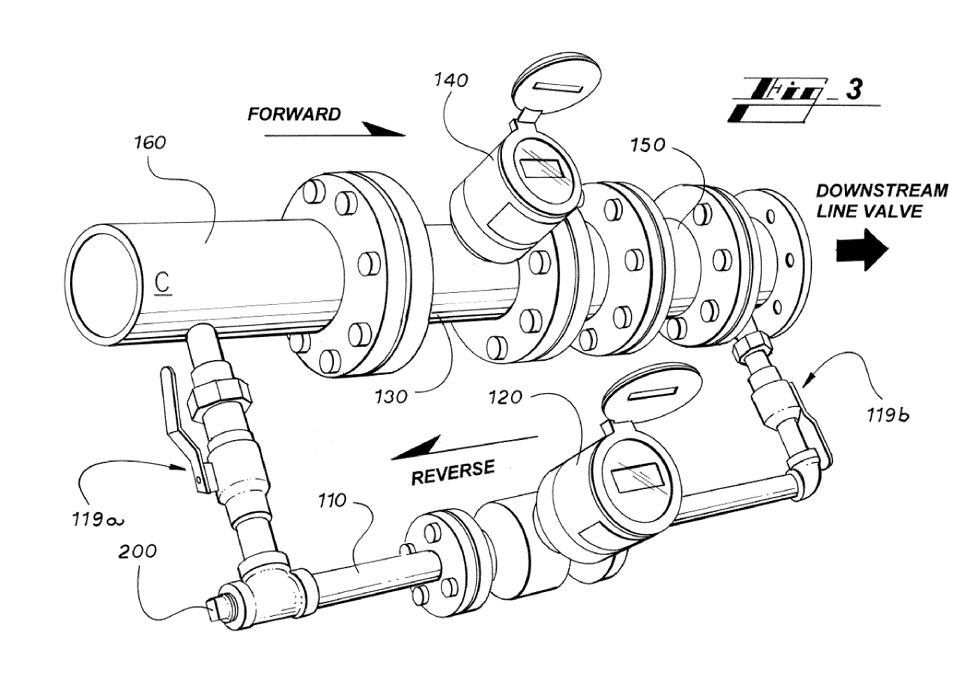

In that form of the preferred embodiment of the present invention chosen for purposes of illustration, FIGS. 1 and 2 show system 100 operable with water conduit C, such as a potable water supply line for a public water system, comprising supply line Cₛ and outlet line Cₒ. System 100 preferably includes first conduit 110, first electromagnetic fluid flow meter 120, second conduit 130, second electromagnetic fluid flow meter 140, and flow control valve 150. System 100 is preferably operable with water supply pipeline C to determine and record a net volume of water flow therethrough via measuring a rate of flow of the water.

In operating the system in connection with a main water line, such as found in a typical municipal water system, it has been found that electromagnetic fluid flow meters sold by Siemens as model nos. 8000 or 5100 may be useful as fluid flow meters 120 and 140, but many other commercially available mag meters may be useful and are well known in the art. System 100 may further be operable with a control device (not shown) that receives one or more output signal from each of first and second electromagnetic fluid flow meter 120, 140, as is known in the art. As will be understood by those skilled in the art, an indication of one or more of net volume of water flow, instantaneous water flow rate, average water flow rate, peak water flow rate, or the like may be provided locally by system 100 or remotely, such as via an electronic communication network. Mag meters are currently commercially available that may be configured to provide downloadable data logging information that may be monitored for data relating to a specific date and time. Such meters can typically be configured for wireless communication so that data may be accessed remotely, saving substantial time and expense in reading and checking the meters. Further, the meters may be configured to provide some type of warning or error message should the meter fail to operate properly.

Second conduit 130 is preferably installed in-line with the water supply pipeline C. As such, a first proximate end of second conduit 130 may be in fluid communication with supply line Cₛ, and a second distal end of second conduit 130 may be in fluid communication with output line Cₒ. Thus, it is generally preferred that second conduit 130 be approximately the same size and shape as water supply pipeline C. Second electromagnetic flow meter 140 may be operationally employed within second conduit 130 to measure the rate of flow therethrough, and flow control valve 150 may be disposed downstream from second flow meter 140. Optionally, adjustable length conduit 160 may be disposed between second conduit 130 and supply conduit Cₛ, to assist in adjoining the compound mag meter into the intended section of water supply pipeline C. It should be understood that when second conduit 130 is said to be “connected to” or “in fluid communication with” water supply pipeline Cₛ, such connection may or may not include adjustable length conduit 160.

First conduit 110 is preferably in operable fluid communication with water conduit C at a location upstream of second electromagnetic fluid flow meter 140 and flow control valve 150, such as via joint 111. Connecting joint 111 may be formed as a tapped joint, a saddle joint, a molded joint, or via any conventional fluid conduit connection means and/or techniques. Similarly, first conduit 110 may, alternatively, be operable with water conduit C via second conduit 130, such as where adjustable length conduit section 160 is not included, wherein joint 111 is defined as the intersection of first end 113 of first conduit 110 and second conduit 130. In any event, first end 113 of first conduit 110 is preferably located at a distance from second electromagnetic flow meter 140 sufficient to reduce an effect on a metering accuracy of second electromagnetic fluid flow meter 140 associated with turbulence or flow irregularities potentially caused by first conduit 110.

First conduit 110 preferably includes adjustable-length conduit section 170 and first electromagnetic fluid flow meter 120 disposed in-line, i.e. in serial connection, therewith, whereby any water flow through first conduit 110 is preferably measured, recorded, and/or processed by first electromagnetic fluid flow meter 120. For such purpose, first electromagnetic fluid flow meter 120 may include an on-board register, or may be operable with a remote register or processor. As with adjustable-length conduit section 160, discussed above, adjustable-length conduit section 170, may be replaced with one or more fixed-length conduit section, or may be omitted entirely, such as in new installations of process conduit.

First conduit 110 is preferably further operable with water conduit C at a location downstream of second electromagnetic fluid flow meter 140 and flow control valve 150, such as via joint 115 connecting flow control valve 150 and second end 117 of first conduit 110. Thus, first conduit 110 preferably acts as a bypass conduit around second electromagnetic fluid flow meter 140 and flow control valve 150, whereby water may flow through process fluid conduit C when flow control valve 150 is closed.

In a preferred potable water supply application, first conduit 110 preferably comprises a conduit formed of a suitable material, such as ductile iron, cast iron, polyvinyl chloride, or the like, having an internal diameter of approximately 1″. Accordingly, a conduit section associated with first electromagnetic fluid flow meter 120 preferably likewise has an internal diameter of approximately 1″. As should be understood, however, first conduit 110 and a conduit section associated with first electromagnetic fluid flow meter 120 may be selected to have other cross-sectional shapes and/or sizes. First conduit 110 may preferably further include valves 119, for example disposed proximate first end 113 and second end 117, whereby maintenance of first conduit 110 and/or first electromagnetic fluid flow meter 120 may be performed without shutting off flow through process fluid conduit C.

First electromagnetic fluid flow meter 120 preferably includes a power source 125, such as in the form of a battery, a solar-power generator, and/or the like, whereby adequate electrical power may be supplied for normal operation of first electromagnetic fluid flow meter 120 when electrical service is unavailable, such as due to remote location, power failure, or the like. In such normal operation, first electromagnetic fluid flow meter 120 preferably creates a magnetic field that induces an electrical current in the fluid disposed within first conduit 110. A sensor device of first electromagnetic fluid flow meter 120, such as a pair of electrodes, is preferably operable to output a signal corresponding to an electrical potential between the electrodes. First electromagnetic fluid flow meter 120, or, alternatively, a remote control device or register, is preferably operable to determine a value of the velocity of the water within first conduit 110 based on the output signal of the sensor device. The determined velocity value may be recorded, and/or used to compile a water consumption value, approximately equal to a total volume of water flowing through first conduit 110 during a relevant period of time.

Second electromagnetic fluid flow meter 140 is preferably configured in an analogous manner as first electromagnetic fluid flow meter 120, and is preferably adapted to operate with a larger diameter conduit. In one exemplary and non-limiting embodiment, second conduit 130 has an internal diameter approximately six times greater than the internal diameter of first conduit 110. Thus, in the preferred potable water supply application described above, second conduit 130 preferably comprises a pipe formed of a suitable material and having an internal diameter of approximately 6″. Accordingly, in the preferred potable water supply application, supply conduit Cₛ and outlet conduit Cₒ preferably likewise comprise pipes formed of suitable material and each having an internal diameter of approximately 6″, whereby use of system 100 in fire prevention supply lines is enabled. It should be noted, however, that although the preferred ratio of the cross-sectional area of second conduit 130 to the cross-sectional area of first conduit 110 is approximately 6:1, the ratio may be as great as approximately 10:1, or more, and may be as small as approximately 1:1. The size of the conduits is limited only by the availability of mag meters suitable to measure anticipated flow rates in said conduits. One advantage of mag meters in large diameter pipe applications is that the cost of mag meters does not rise proportionally to the size of the pipe as is the case with turbine meters. It has been found that compound mag meters designed for 6″ water pipelines may be manufactured for about the same cost as compound meters using mechanical flow meters, and that compound mag meters designed for 8″ pipe may be produced even more cheaply than comparably sized mechanical compound turbine meters.

The sizes selected for the first and second conduits, 110, 130, may influence the selection of the first and second flow meters 120, 140 and the configuration of flow control valve 150. In the described configuration, first flow meter 120 is intended to measure lower anticipated flow rates, and second flow meter 140 the higher anticipated flow rates. Flow meters should be selected that provide acceptable accuracy at the flow rates anticipated for the selected pipe diameters. In addition, the flow meters should preferably have a “crossover range”, that is, a flow range at which the two meters are about equally accurate at measuring flow rates. This “crossover range” is where flow control valve 150 should be designed to allow flow through second conduit 130.

As shown in greater detail in FIG. 2, flow control valve 150 preferably comprises generally planar member 153 hingedly operable with an interior of conduit section 151 via hinge 155. Generally planar member 153 is preferably biased in a first position, shown in FIG. 2, wherein generally planar member 153 sealingly engages projection 157 proximate a peripheral portion of generally planar member 153. Thus, generally planar member 153 may prevent backflow of water, i.e. flow of water from outlet conduit Cₒ to supply conduit Cₛ, when in the first position. Generally planar member 153 preferably further prevents downstream flow through second conduit 130 when a water pressure downstream thereof is less than a water pressure upstream thereof by an amount less than a predetermined threshold, referred to as the cracking pressure. When the upstream water pressure exceeds the downstream water pressure by an amount greater than the cracking pressure, generally planar member 153 preferably swings about hinge 155 to allow water to flow therepast.

It is important to note that a shape and contour of projection 157 is preferably selected to reduce turbulence or flow irregularities caused by water flow therepast. Additionally, hinge 155 is preferably operable to allow generally planar member 153 to open quickly once the cracking pressure is exceeded, whereby transition period may be reduced, and flow rates in second conduit 130 reach levels for which second electromagnetic fluid flow meter 140 is accurate in a short period of time. Furthermore, a distance between second electromagnetic fluid flow meter 140 and projection 157 is preferably selected to reduce the affect of any turbulence caused by projection 157 and/or generally planar member 153 on the accuracy of second electromagnetic fluid flow meter 140. Finally, the diameter of each of supply conduit Cₛ, second conduit 130, and outlet conduit Cₒ, is preferably selected to reduce turbulence therewithin associated with typical maximum flow rate values expected based on the application. Nonetheless, other flow control devices, including alternative valves, or the like, may be utilized, which facilitate realization of the advantages of the preferred flow control valve 150.

An additional advantage mag meters have over other types of meters is that they can measure flow rate in both directions through a pipe. One can take advantage this operational property by making the compound metering system of the present invention self-testing. This can be a significant advantage to municipalities that are required to test in-line water meters on a regular basis. The self-testing procedure may be used without hiring third party companies or purchasing expensive equipment, which may result in significant savings in operational cost.

Referring now to FIG. 3, one preferred embodiment of the present invention is shown that enables one to practice such a self testing procedure. The system in FIG. 3 is similar to that shown in FIG. 1, with a primary difference being the addition of a removable plug 200 in the first conduit 110. Removable plug 200 may be located upstream from first flow meter 120. To administer the flow test, one should first close a line isolation valve downstream from C₀ so that water does not flow downstream from the metering system. The total forward flow for second flow meter 140 and the total reverse flow for first flow meter 120 should be recorded. Then both of valves 119a, 119b may be closed, to stop flow in the first conduit 110. Removable plug 200 may then be removed, and a hose attached to direct water flow to a desired location, such as the ground, or, preferably, a measuring vessel of some sort so that water flow amounts may be verified. The downstream valve within the first conduit 119b may then be opened. This will allow water to flow forward through second flow meter 140, and then reverse through first flow meter 120, through the hose, and, optionally, into the collection vessel. The two flow meters should register the same flow rate at this point. The flow meters may then be calibrated as may be necessary to reflect the appropriate flow rate. The flow rate may be cross-checked by directing the water flow into a graduated vessel of appropriate size, and checking the amount of time taken to fill the vessel.

As described in the preferred potable water supply application, system 100 is preferably operable to measure flow rates and totalize flow volumes at flow rates from one half gallon per minute to ten thousand gallons per minute. Furthermore, the maximum error tolerance of the preferred embodiment is approximately 2%. Thus, revenue generated by water metering can be dramatically increased due to a reduction in the total volume of unaccounted water. Additionally, savings may be achieved by decreasing the pumping cost of maintaining adequate pressure in the potable water distribution system. Accordingly, it is contemplated that numerous conventional compound meter systems may be replaced with compound meter systems according to the present invention. Therefore, numerous methods are contemplated for using and/or making a compound meter system according to the present. Of course, further flow rate variation and/or greater error tolerance could be applied without departing from the scope of the present invention, and while continuing to provide the benefits thereof over conventional systems.

For example, in one method, one or more component(s) of system 100 may be supplied separately or in a disassembled state. The one or more component(s) may then be retrofit into an existing compound meter system, such as when one or more components thereof wear out or break, or at another time when replacement is desired. Over time, each component of the existing compound meter system may be replaced by components of system 100. As mentioned above, such retrofit may be facilitated by one or more of adjustable length conduit sections 160 and 170, such as in the form of extendable conduit sections, interchangeable sections of different lengths, mutually-engageable modular sections, or the like, whereby first and/or second conduit 110, 130, may engage existing fittings or conduit sections.

Alternatively, system 100 may be supplied in a pre-assembled state, wherein wholesale replacement of an existing compound meter system is simplified, or for use in new installations. Furthermore, system 100 may be provided in a sealable pit enclosure. Finally, system 100 may be provided in a custom format to facilitate convenient replacement of existing meters. For example, where a compound meter system of given dimensions needs to be replaced, system 100 may be manufactured to include substantially similar dimensions, whereby installation of system 100 into an existing potable water distribution network may be simplified, such as by eliminating the need to modify the existing supply conduit and outlet conduit.

As will be understood by those ordinarily skilled in the art, where, as in the preferred embodiment shown and described, both fluid flow meters are formed as electromagnetic fluid flow meters 120, 140, account may be taken of any electrical current induced in first conduit 110 and second conduit 130 by a magnetic field created by second electromagnetic fluid flow meter 140 and first electromagnetic fluid flow meter 120, respectively. Alternatively, shielding, sequential creation of magnetic field, or other precaution may be taken to prevent first electromagnetic fluid flow meter 120 from inducing an electrical current in second conduit 130, and vice-versa. Additionally, although the preferred embodiment includes two electromagnetic fluid flow meters, alternative numbers of flow meters and respective associated conduits and flow control valves, such as three or more flow meters and conduits. As will further be understood by those ordinarily skilled in the art, and as discussed above, system 100 may be formed as a unitary device, whereby incorporation thereof in a process fluid conduit may be simplified. Such a unitary device may include permanent or removable connections between first conduit 110 and second conduit 130 and between conduit section 151 and first conduit 130, or may include seamless transitions therebetween. As such, system 100 may be provided in a fully assembled state, in a partially assembled state, or in a completely disassembled state.

While reference to such a potable water supply conduit is made in the disclosure, it should be understood that system 100 may be implemented in any conduit carrying a conductive fluid, including but not limited to liquids having dissolved substances, liquids carrying suspended matter, slurries, or the like.

Having thus described exemplary embodiments of the present invention, it should be noted by those skilled in the art that the within disclosures are exemplary only and that various other alternatives, adaptations, and modifications may be made within the scope and spirit of the present invention. Accordingly, the present invention is not limited to the specific embodiments as illustrated herein, but is only limited by the following claims.

What is claimed is at least:

1. A system for measuring a rate of water flow through a water delivery pipe comprising:
a first conduit having a first electromagnetic flow meter operable therewith to measure a characteristic of water flow therethrough;
a second conduit disposed in-line with the water delivery pipe and in parallel with said first conduit and having a second electromagnetic flow meter operable to measure a characteristic of water flow through said second conduit; and
a water flow control device operable with said second conduit to selectively prevent flow of the water through said second conduit.

2. The system of claim 1, wherein said water flow control device prevents water from flowing through said second conduit and allows water to flow through said first conduit if the differential between the pressure of water upstream from the valve and the pressure of water downstream from the valve is below a selected value.

3. The system of claim 2, wherein said water flow control device allows water to flow through said second conduit if the differential is above a selected value.

4. The system of claim 3, wherein said first conduit has a smaller cross-section than said second conduit.

5. The system of claim 4, wherein said first electromagnetic flow meter is designed to more accurately measure lower water flow rates than said second electromagnetic flow meter.

6. The system of claim 1, wherein said first conduit is in fluid communication with said water delivery pipe at a point upstream from said second conduit, and at a point downstream from said water flow control device.

7. The system of claim 1 wherein each of said first and second electromagnetic flow meters has an electrical power source independent from a municipal power source.

8. The system of claim 7 wherein said independent power source is selected from the group consisting of lithium batteries, alkaline batteries and solar power.

9. The system of claim 4, wherein the ratio of the diameter of said second conduit to the diameter of said first conduit is about 6:1.

10. A compound water metering device for connecting to a water pipeline comprising:
a first conduit having a first electromagnetic flow meter operable therewith to measure a characteristic of water flow therethrough;
a second conduit in parallel with said first conduit and having a second electromagnetic flow meter operable to measure a characteristic of water flow through said second conduit; and
a water flow control device operable with said second conduit to selectively prevent flow of the water through said second conduit.

11. The compound metering device of claim 10, wherein the water flow control device is disposed within said second conduit.

12. The device of claim 11, wherein said first conduit is in fluid communication with said second conduit such that water will flow through said first conduit when said water flow control device prevents the flow of water through said second conduit.

13. The system of claim 12, wherein said water flow control device prevents water from flowing through said second conduit if the differential between the pressure of water upstream from the valve and the pressure of water downstream from the valve is below a selected value.

14. The device of claim 10, wherein said first conduit has a smaller cross-section than said second conduit.

15. The device of claim 14, wherein said first electromagnetic flow meter is designed to more accurately measure lower water flow rates than said second electromagnetic flow meter.

16. The system of claim 14, wherein the ratio of the diameter of said second conduit to the diameter of said first conduit is about 6:1.

17. A method of calibrating a compound flow meter installed in a water supply line, said compound flow meter comprising:
a first conduit having a first flow meter, said first conduit having an upstream stop valve and a downstream stop valve and a removable plug positioned between said upstream stop valve and said flow meter, said first conduit having an upstream end in fluid communication with an upstream portion of the water supply line and a downstream end in fluid communication with a downstream portion of said water supply line;
a second conduit having a second flow meter, said second conduit in fluid communication with said water supply line at a point between the upstream and downstream connections of said first conduit;
the calibration method comprising the steps of:
(a) closing a valve on said water supply line downstream from the downstream end of said first conduit to cease fluid flow through said water supply line;
(b) closing said upstream and downstream stop valves of said first conduit;
(c) removing said removable plug to allow water to exit said first conduit;
(d) opening said downstream stop valve, so that water flows forward through said second conduit and back through said first conduit and exits the removable plug opening;
(e) calibrating said first and second meters to match the flow rate from the plug opening.

18. The calibration method of claim 14, wherein the water flow from the plug opening is directed toward a graduated vessel so that flow rate may be measured.

19. A system for measuring a flow rate of a fluid through a pipeline comprising:
a first conduit having a first electromagnetic flow meter operable therewith to measure a characteristic of fluid flow therethrough;
a second conduit disposed in-line with the pipeline and in parallel with said first conduit and having a second electromagnetic flow meter operable to measure a characteristic of fluid flow through said second conduit; and
a fluid flow control device operable with said second conduit to selectively prevent flow of the fluid through said second conduit.

20. The system of claim 19, wherein said fluid flow control device prevents fluid from flowing through said second conduit and allows fluid to flow through said first conduit if the differential between the pressure of fluid upstream from the valve and the pressure of fluid downstream from the valve is below a selected value.
